(19) United States
(12) Patent Application Publication
(10) Pub. No.: US 2006/0043064 A1
(43) Pub. Date: Mar. 2, 2006

(54) Plasma processing system and method

(76) Inventors: Junichi Tanaka, Hachioji (JP); Takehisa Iwakoshi, Kokubnji (JP); Seiichiro Kanno, Kodaira (JP); Go Miya, Hachioji (JP); Motohiko Yoshigai, Hikari (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/934,383

(22) Filed: Sep. 7, 2004

(30) Foreign Application Priority Data
Aug. 25, 2004 (JP) 2004-245737

(51) Int. Cl. C23F 1/00; G01L 21/30

(52) U.S. Cl. 216/61; 427/8; 427/569; 216/67; 156/345.28

(57) ABSTRACT

A plasma processing system includes a process chamber equipped with a gas supply unit, a gas exhaust and an electromagnetic energy supply unit for generating plasma from process gasses, thereby subjecting a specimen placed on a specimen stage to a plasma process. The system includes a spectrometer detecting a spectrum of plasma emission generated in the chamber, flow controllers controlling flow rates of process gasses to be supplied, and a controller controlling the flow controllers. The controller includes a calculation unit for calculating an amount of reaction byproducts generated in the chamber, in accordance with the spectrum of the plasma emission detected with the spectrometer and an input unit for inputting a target timeline of the amount of reaction byproducts, and controls amounts of the process gasses such that a calculation result of the amount of reaction byproducts becomes coincident with the input target timeline.

### BACKGROUND OF THE INVENTION

1. Field of the Invention

The present invention relates to plasma processing techniques and more particularly to plasma processing techniques capable of controlling an etching shape as desired.

2. Description of the Related Art

A plasma etching system to be used during manufacture processes for semiconductor devices etches a polysilicon layer on a wafer by using as a mask a predetermined resist pattern formed by a lithography system or the like on the polysilicon layer, to thereby form a CMOS gate electrode made of polysilicon. By using such an etching system, new devices (micro machines) such as MEMS (Micro Electro Mechanical System) and NEMS (Nano Electro Mechanical System) have been manufactured recently.

Plasma etching etches a wafer by a scheme called RIE (Reactive Ion Etching) using ions and radicals in plasma. In RIE, a bias voltage applied to a wafer attracts charged ions to the wafer. Therefore, ions are accelerated along a direction perpendicular to the wafer to progress anisotropic etching.

In the anisotropic etching, most ions are incident on the etch front. Ions incident on the side walls of a pattern are scare. Therefore, etching progresses only along the direction perpendicular to the wafer. On the other hand, since radicals in plasma are not charged, they are not influenced by the bias electric field so that they become incident upon the wafer at various angles. Therefore, isotropic etching is induced. Since radicals abrade the pattern side wall in isotropic etching, the pattern width is thinned.

In RIE by a plasma etching system, since both ions and radicals exist in plasma, both the anisotropic and isotropic etching progress at the same time. Reaction byproducts formed by the etching at the etching progressing plane attach again the pattern side wall, so that a side wall protective film is formed which protects the pattern side wall from the isotropic etching by radicals.

Knowledge relating to the side wall protective film made of reaction byproducts is disclosed, for example, in “Journal of Vacuum Science and Technology B, Vol. 21, No. 5, pp 2174-2183 by X. Detter. In RIE, the side wall shape of an etched pattern is determined by a balance between isotropic etching and a side wall protection by reaction byproducts. For example, if isotropic etching is stronger than the side wall protection by reaction byproducts, the side walls of a gate electrode are notched or have a reverse taper shape, which are otherwise abraded vertically. Conversely, if the isotropic etching is weaker, the side walls are gradually protruded by the accumulation of reaction byproducts attached to the side walls, and have a normal taper shape.

In conventional etching of a gate electrode, an STI (Shallow Trench Isolation) and the like, etching is usually executed by combining a plurality of processes each having a fixed process condition, to thereby adjust the etching shape of a pattern side wall. Such techniques are disclosed in the above-cited document by Detter.

JP-A-6-216069 suggests the following approach. When an underlying oxide film is exposed immediately before the completion of etching a polysilicon film to form a polysilicon gate electrode, the amount of reaction byproducts reduces so that the side wall protective film becomes thin and a notch is formed on the lower side wall of the gate electrode. In order to solve this problem, either a supply amount of etching gas is reduced or the addition amount of gas equivalent to the reaction byproducts is increased.

### SUMMARY OF THE INVENTION

However, a conventional etching process such as shown by the above-cited document by Detter uses a fixed process condition at each etching step. Therefore, the etching shape may be varied because of a change in the wall state of a process chamber with time, and other reasons. Since the amount of reaction byproducts emitted from a wafer changes as the etching progresses, the side wall shape may be varied.

The approach disclosed in JP-A-6-216069 intends to maintain constant the amount of reaction byproducts in accordance with a measurement value of an emission monitor or to maintain constant the ratio between etchant (radicals) and reaction byproducts, and cannot control the pattern side wall shape to have a desired shape.

The present invention has been made in consideration of these problems and provides plasma processing techniques capable of controlling an etched cross sectional shape as desired.

In order to solve the above problems, the invention provides a plasma processing system including the following means. Namely, according to one aspect of the present invention, there is provided a plasma processing system including: a process chamber equipped with gas supply means for supplying a plurality of process gases, a gas exhaust series for exhausting gas and a specimen stage; and electromagnetic energy supply means for supplying a high frequency power to the process gasses supplied to the process chamber, wherein the electromagnetic energy supply means changes the process gasses to plasma and a specimen placed on the specimen stage is subjected to a plasma process, and the plasma processing system comprising: a spectrometer for detecting a spectrum of plasma emission generated in the process chamber; flow controllers for controlling flow rates of a plurality of process gasses to be supplied; and a controller for controlling the flow controllers, wherein the controller includes a calculation unit for calculating an amount of reaction byproducts generated in the process chamber, in accordance with the spectrum of the plasma emission detected with the spectrometer and an input unit for inputting a target timeline of the amount of reaction byproducts, and controls amounts of the process gasses in such a manner that a calculation result of the amount of reaction byproducts becomes coincident with the input target timeline.

With this configuration, the invention can control to set the optimum amounts of reaction byproducts and radicals so that a desired etched cross sectional shape can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a plasma etching system according to an embodiment of the invention.

FIGS. 2A and 2B are diagrams illustrating the states of a wafer etched by the plasma etching system.

FIGS. 3A and 3B are diagrams illustrating wafers etched by the plasma etching system.

FIG. 4 is a graph illustrating the relation between the total flow rate of supply gas and the amount of reaction byproducts.

FIG. 5 is a graph illustrating an emission spectrum measured with a spectrometer.

FIG. 6 is a graph showing a setting example of a change in the amount of reaction byproducts with time.

FIG. 7 is a diagram showing the shape of pattern side walls, with the setting of the change in the amount of reaction byproducts with time shown in FIG. 6.

FIG. 8 is a graph showing another setting example of a change in the amount of reaction byproducts with time.

FIG. 9 is a diagram showing the shape of pattern side walls, with the setting of the change in the amount of reaction byproducts with time shown in FIG. 8.

FIG. 10 is a graph showing a setting example of a change in the amount of reaction byproducts with time and a setting example of oxygen radicals.

### DETAILED DESCRIPTION OF THE EMBODIMENTS

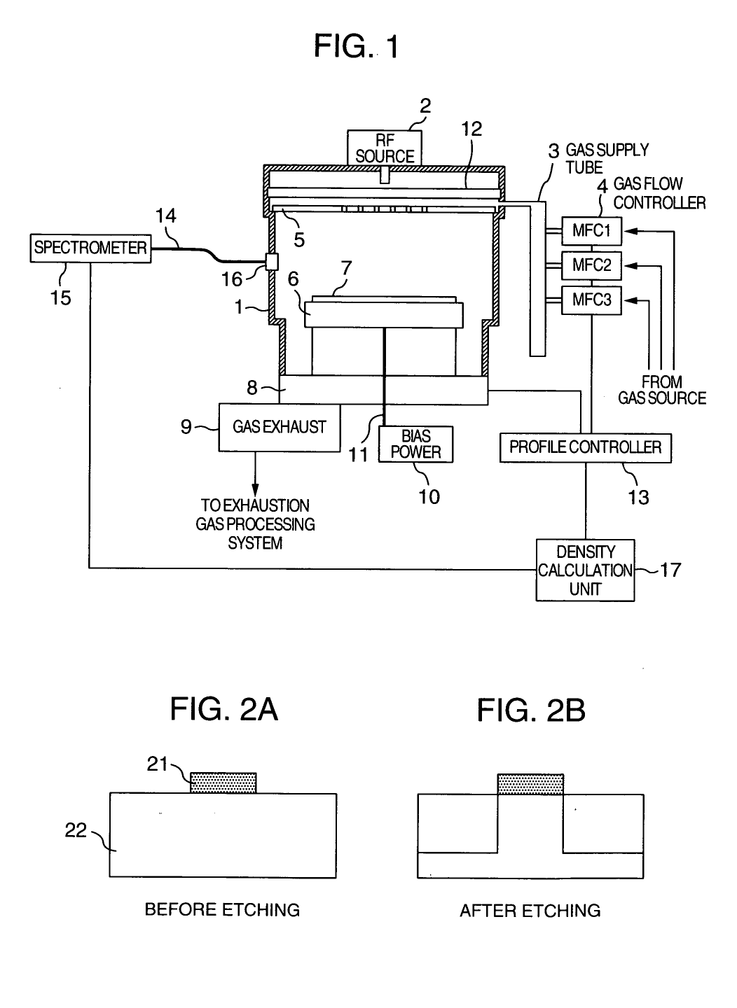

Best embodiments of the invention will be described with reference to the accompanying drawings. FIG. 1 is a diagram showing a plasma etching system according to the embodiment of the invention. By using this etching system, workpieces such as a wafer and a MEMS (micro machines) can be worked or etched by using plasma. The system is equipped with gas flow controllers 4 and a gas supply tube 3 to regulate the amounts of process gasses to be supplied to a process chamber 1. Process gas at a flow rate determined by the process condition is supplied by each gas flow controller 4, and introduced from a gas supplier 5 into the process chamber 1 via the gas supply tube 3. The gas supplier 5 is a quarts plate with many through holes to supply gasses like a shower head and called a quartz shower plate. The process gas flows in a gap between a quartz plate 12 and gas supplier 5 reaches holes of the gas supplier 5 is jetted out into the process chamber.

The system is also provided with an electromagnetic energy supply means (RF source) 2 for supplying electromagnetic energy necessary for changing process gas to plasma, a gas exhaust series 9 for exhausting process gas to maintain the process chamber in a low pressure state, and a pressure adjusting valve 8 for adjusting a pressure in the process chamber. The system is also provided with a specimen stage 6 on which a wafer 7 is placed, a bias power supply 10 for supplying a high frequency bias power to attract ions in plasma to the wafer, and a bias power transmission path 11.

The process chamber is equipped with an observation window 16 for observing the emission state of plasma, an optical fiber 14 for guiding light from the observation window, and a spectrometer 15 to obtain plasma emission spectra. The process chamber is also equipped with a density calculation unit 17 for receiving a plasma emission state signal from the spectrometer 15 and calculating the amount of reaction byproducts in the process chamber. An profile controller 13 controls the flow rate of gas supplied to the process chamber and a pressure in the process chamber in accordance with the amount of reaction byproducts calculated by the density calculation unit 17. It is therefore possible to control the etched shape (cross sectional shape) of a fine pattern on the surface of the specimen 7 as desired.

FIGS. 2A and 2B are diagrams illustrating the state of a wafer etched by the plasma etching system. For plasma etching, first as shown in FIG. 2A, a portion of a subject layer 22 on a wafer is covered with a mask 21. Next, as shown in FIG. 2B, the subject member is etched by plasma. As for the material of the mask 21, a hard mask typically silicon oxide and silicon nitride or a resist mask made of organic material is generally used. Although the subject member 22 is often silicon compound, metal deposited on the wafer may also be used.

During plasma etching, etched materials are emitted in plasma as reaction byproducts. The reaction byproducts are exhausted from the gas exhaust series 9 by the flow and diffusion of gas supplied from the gas supplier 5. However, a certain constant amount of reaction byproducts always remain in the process chamber 1, this amount being determined by a balance between the emission amount of reaction byproducts from the wafer and the exhaustion efficiency. The reaction byproducts also contain components emitted from the wafer and dissociated in plasma. For example, while silicon is etched by using chlorine-containing gas, reaction byproducts, mainly SiCl₂ and SiCl₄, are emitted from the wafer, and these are dissociated in plasma to generate Si, SiCl, SiCl₃ and the like. If HBr or the like is used as etching gas, reaction byproducts such as SiBr generate similar dissociation seeds. If fluorocarbon-containing gas is used, reaction byproducts such as SiF₄ generate similar dissociation seeds. The reaction by products further include ones generated by dissociation of the etching gas.

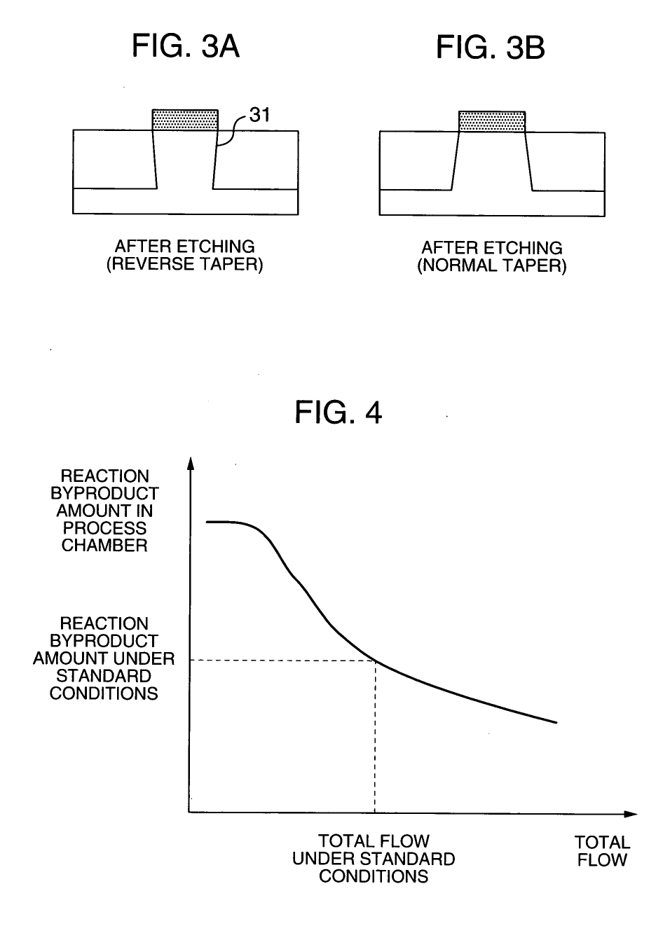

FIGS. 3A and 3B are diagrams illustrating the state (cross sectional shape) of wafers etched by the plasma etching system. As reaction byproducts remaining in the process chamber 1 of the plasma etching system become again incident upon the wafer 7, they attach the side walls 31 of a fine pattern during etching. Since the side walls are abraded by a constant amount by radicals in plasma during etching, the etched state of the side walls is the reverse taper shape as shown in FIG. 3A if reaction byproducts do not exist completely. The vertical side wall shape can be obtained when the amount of reaction byproducts attached to the side walls is balanced with the abrasion amount of side walls by radicals, and if many reaction byproducts exist, the etched state is a normal taper shape as shown in FIG. 3B.

As the etching gas, a mixture of a plurality type of gasses is used in order to maintain a predetermined etched shape, an underlying layer selection ratio, and a mask selection ratio. A total sum of gasses supplied to the process chamber 1 is called a gas total flow rate. As the gas total flow rate is changed by the gas flow controllers 4, the exhaustion efficiency of reaction byproducts emitted from the wafer changes so that the amount of reaction byproducts in the process chamber can be controlled.

FIG. 4 is the graph illustrating the relation between the total flow rate of supply gasses and the amount of reaction byproducts in the process chamber. As shown, as the gas total flow rate is increased, the exhaustion efficiency of reaction byproducts is improved and the amount of reaction byproducts in the process chamber is reduced. As the gas total flow rate is reduced, the exhaustion efficiency of reaction byproducts is degraded and the amount of reaction byproducts in the process chamber is increased.

When the total flow rate of supply gasses is changed to control the amount of reaction byproducts, it is desired to maintain the partial pressure of each gas component to keep the balance between the etchant in plasma and reaction byproducts. To this end, the flow rate of each gas component is changed at generally the same ratio. In order to adjust the distribution of reaction byproducts on the wafer 7, the layout of holes of the shower plate used as the gas supplier 5 is optimized. In particular, if the holes of the shower plate are concentrated on the central area and the distance between the shower plate and wafer 7 is made short, the exhaustion efficiency of reaction byproducts near the wafer can be conveniently adjusted by the total flow rate of supply gasses.

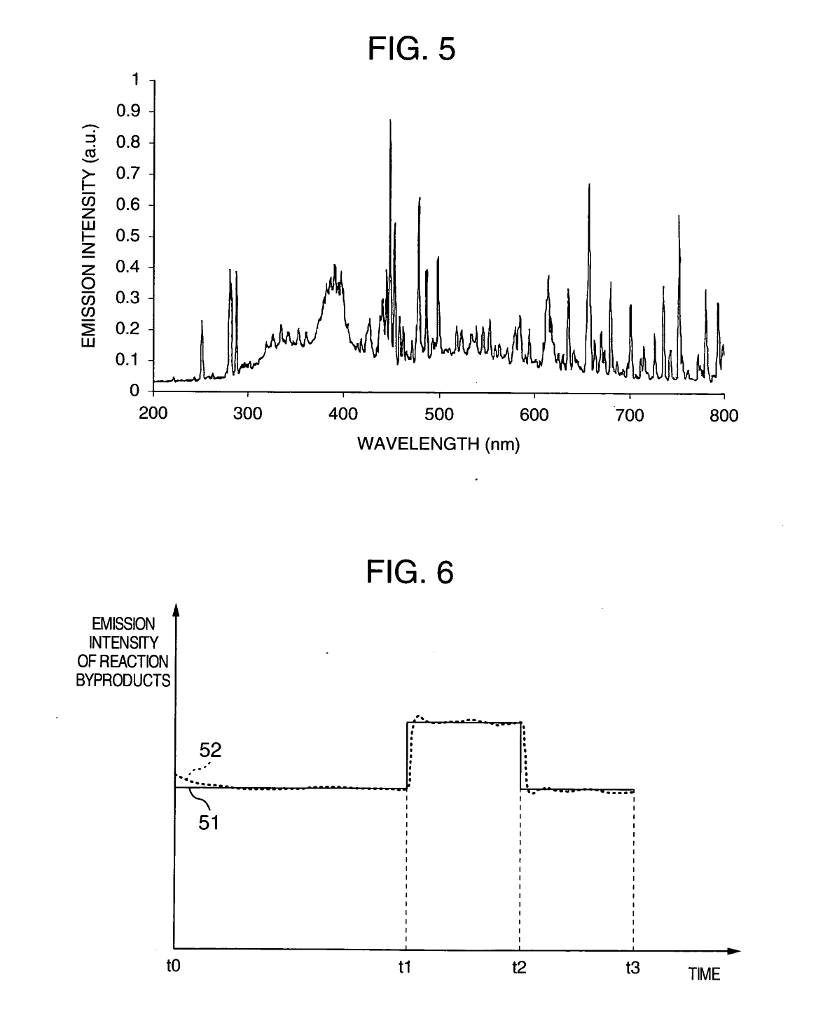

FIG. 5 is a graph showing an emission spectrum measured with the spectrometer 15. The amount of reaction byproducts in plasma can be measured by observing the emission intensity at a specific wavelength of the emission spectrum shown in FIG. 5. In actual, the emission intensity of reaction byproducts is different from the amount of reaction byproducts, because of the influence of an electron temperature and an electron density of plasma. However, no practical problem arises if control factors are limited, even if it is assumed that the emission intensity of reaction byproducts is taken as the amount of reaction byproducts. For example, if the total flow rate is changed as in the case of this invention, a change in the electron temperature and the electron density is small so that the amount of reaction byproducts can be measured from a change in the emission intensity of reaction byproducts. An actinometry method may be used to measure the amount of reaction byproducts more correctly. With the actinometry method, inert gas such as argon is slightly added to the process gas, and the ratio between the emission intensity of the inert gas to the emission intensity of reaction byproducts can be considered as the amount of reaction byproducts. This method can eliminate the influence of a change in the electron temperature. The amount of reaction byproducts may be calculated from a sum of several wavelengths of the emission spectrum shown in FIG. 5. This is because as described earlier reaction byproducts may be dissociated in plasma and a plurality type of reaction byproducts are emitted from the wafer.

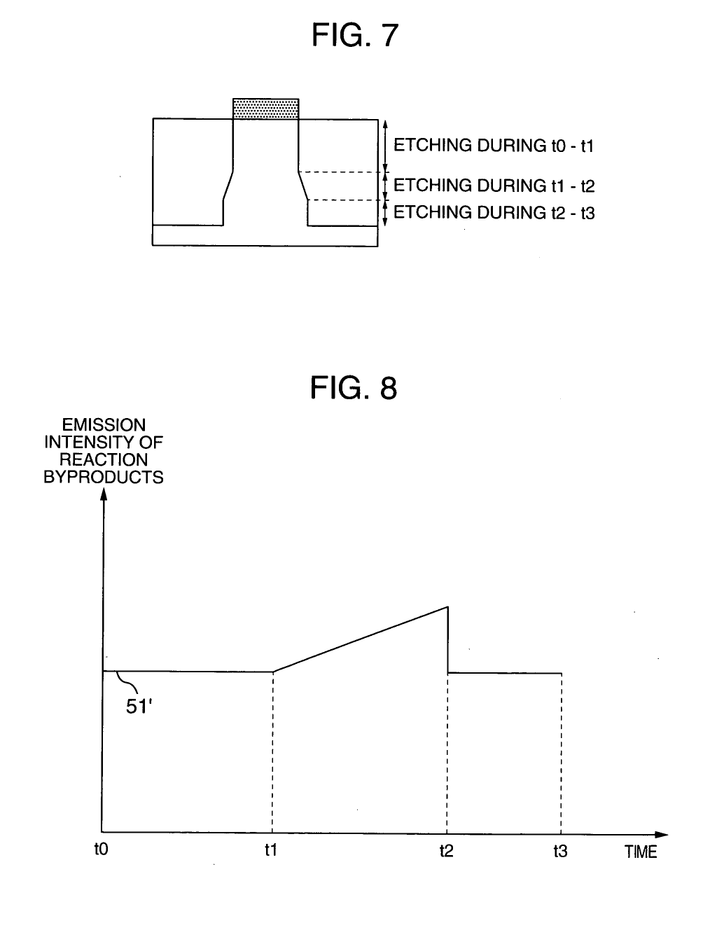

Next, with reference to FIGS. 6 and 7, another embodiment of the present invention will be described. FIG. 6 is a graph showing a setting (design curve) example of a change in the amount of reaction byproducts with time. When plasma etching starts at time t0, the etching shape controller 13 monitors reaction byproducts by using the spectrometer 15, and controls the gas total flow rate in such a manner than the emission intensity of reaction byproducts coincides with the design curve 51 set by a user.

As the result of this control, the emission intensity 52 of reaction byproducts changes with time, taking a value near to the set value 51 shown in FIG. 6.

The setting work for such a design curve is not proper if it is performed by viewing a console screen of a system in a clean room. From this reason, a design curve is set by remotely accessing the etching system from a computer in an office via a LAN or the like. In a mass production line, it is desired that the etching system can receive a design curve from a higher level computer or the like which manages all systems.

FIG. 7 is a diagram showing the shape (cross sectional shape) of pattern side walls, with the setting of the change in the amount of reaction byproducts with time shown in FIG. 6. As the amount of reaction byproducts is set large during a period from time t1 to time t2 as shown in FIG. 6, the etched shape having a normal taper cross section can be obtained in the etching period from time t1 to time t2 shown in FIG. 7.

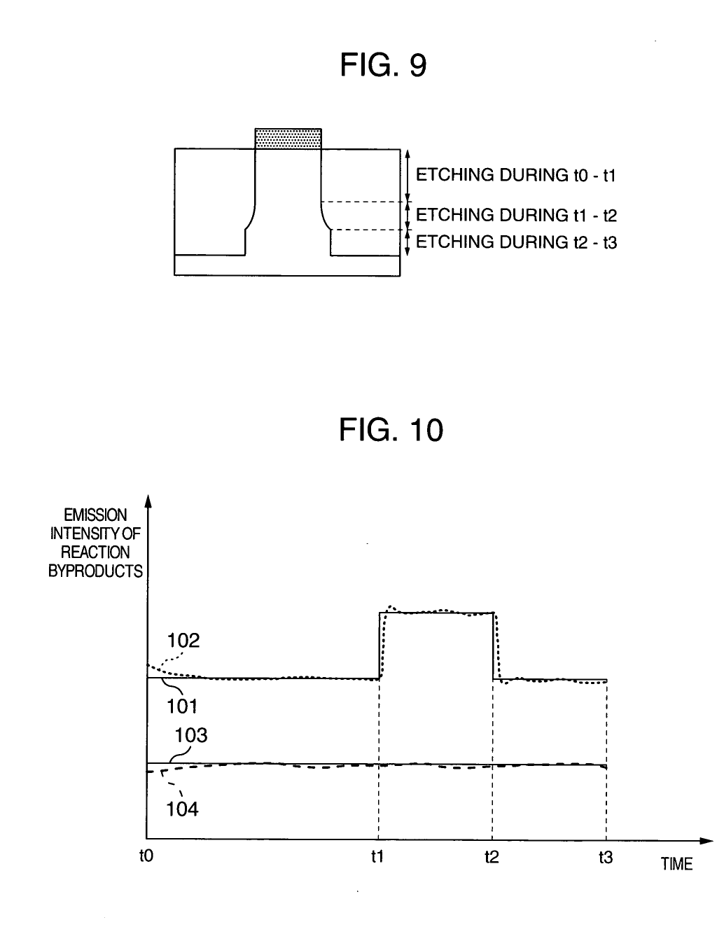

Next, with reference to FIGS. 8 and 9, still another embodiment of the present invention will be described. FIG. 8 is a graph showing another setting (design curve) example of a change in the amount of reaction byproducts with time. If a change in the amount of reaction byproducts with time is set as a design curve 51′ shown in FIG. 8, a curved side wall cross sectional shape such as shown in FIG. 9 can be obtained. Namely, as the amount of reaction byproducts is gradually increased during the period from time t1 to time t2 as shown in FIG. 9, the curved etched shape having the cross section of the normal taper shape can be obtained in the etched period from time t1 to time t2 as shown in FIG. 9.

Even if the perfectly vertical cross sectional shape is intended by maintaining the amount of reaction byproducts at a predetermined value, the skirt portion may have a curved etched shape in some cases because of the influence of surface reaction. In such cases, a design curve gradually reducing the amount of reaction byproducts is set to obtain a reversed etched shape which cancels out the skirt normal taper curve, so that the perfectly vertical shape can be obtained.

In order to control the amount of reaction byproducts by the total flow rate of supply gasses, it is necessary that the result of the flow rate control by the gas flow controllers 4 shown in FIG. 1 is immediately reflected upon the inside of the process chamber 1. There is a time delay until the gas passed through the gas flow controller 4 reaches the gas supplier via the gas supply pipe 3 and is jetted out into the process chamber 1. It is therefore desired that the gas flow controllers 4 are installed as near to the process chamber as possible and the delay time of the flow control is set to 0.5 second or shorter.

As described above, the ratio of reaction byproducts attached to the side walls of a fine pattern is dependent upon the amount of reaction byproducts and the amount of oxygen radicals in plasma. If quartz and the like is used in the process chamber 1, oxygen is supplied also from this quartz. Since oxygen radicals are likely to be influenced by the surface state of the wall of the process chamber 1, the amount of oxygen radicals is likely to vary after successive processes of a number of wafers.

Even if the oxygen flow rate is maintained constant, the amount of oxygen radicals may vary greatly during an etching process. It is therefore necessary for plasma etching using oxygen gas that the emission intensity of reaction byproducts and the emission intensity of oxygen radicals are monitored with the spectrometer to control the oxygen flow rate in each supply gas and maintain constant the amount of oxygen radicals. Even if oxygen is not supplied, oxygen is supplied from quartz components as described above so that it is necessary to control and maintain constant the amount of oxygen radicals.

FIG. 10 is a graph showing a setting (design curve) example of a change in the amount of reaction byproducts with time and a setting example of oxygen radicals. As shown, the gas total flow rate is controlled in such a manner that an emission intensity 102 of reaction byproducts coincides with a design curve 101 set by a user. The supply amount of oxygen is controlled in such a manner that an emission intensity 104 of oxygen radicals coincides with a value 103 set by the user.

In the above description, the amount of oxygen radicals is maintained constant and the amount of reaction byproducts is controlled by controlling the gas total flow rate. Instead, the amount of reaction byproducts may be maintained constant by controlling the gas total flow rate, and by controlling the amount of oxygen radicals, the etched shape is controlled.

If carbon-containing gas such as fluorocarbon gas is used as the process gas, carbon radicals function in a similar manner to oxygen radicals. If nitrogen-containing gas is used as the process gas, nitrogen radicals function in a similar manner to oxygen radicals. It is therefore desired to control carbon radicals or nitrogen radicals. If carbon-containing gas becomes reaction byproducts, oxygen radicals provide the effect of reducing the amount of reaction byproducts to be attached. From this reason, although it is necessary to control the change in supply amount with time, it is necessary to reduce the supply amount of oxygen in order to thicken a pattern.

The rate of reaction byproducts attaching a fine pattern is also dependent upon a wafer temperature. Since the specimen stage 6 is usually equipped with a wafer temperature adjusting mechanism, the wafer temperature can be used as one of control factors.

If the amount of process gasses (etching gasses) is almost constant and the taper angle of a patten side wall cross section can be calculated from the amount of reaction byproducts, the amount of oxygen radicals and a wafer temperature, in place of the setting (design curve) of a change in the amount of reaction byproducts such as shown in FIG. 6, a pattern side wall shape may be input directly and the change pattern of reaction byproducts or oxygen radicals with time is adjusted to match the input side wall shape.

In the above embodiments, although a convex structure such as a gate electrode is formed by etching, a concave groove may be formed. It is particularly suitable for etching a damascene gate and the like.

Also in the above embodiments, a change in the amount of reaction byproducts or oxygen radicals with time is controlled. There is, however, the case wherein it is necessary to control a change in the amounts of three or more kinds of radicals contributing to etching in order to obtain a desired etched shape. In such a case, it is difficult to control separately and independently these three or more kinds of radicals. Therefore, the main components of a plasma emission spectrum are analyzed, and one or two main components contributing greatly to the shape are extracted from a plurality of analyzed main component scores, to control in such a manner that the change in the amounts of the extracted main components with time is made coincident with a desired time change pattern. Instead of the main component analysis, a correlation between the emission spectrum and an etched shape may be checked by using an approach such as a PLS (Partial Least Squares) method to control in such a manner that the time change waveform of PLS scores is made coincident with a desired pattern.

As described so far, by setting a change in the amount of reaction byproducts or oxygen radicals in a process chamber with time, the etched shape of a fine pattern can be controlled as desired.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing system including:
a process chamber equipped with gas supply means for supplying a plurality of process gases, a gas exhaust series for exhausting gas and a specimen stage; and
electromagnetic energy supply means for supplying a high frequency power to the process gasses supplied to the process chamber,
wherein said electromagnetic energy supply means changes the process gasses to plasma and a specimen placed on the specimen stage is subjected to a plasma process,
the plasma processing system comprising:
a spectrometer for detecting a spectrum of plasma emission generated in said process chamber;
flow controllers for controlling flow rates of a plurality of process gasses to be supplied; and
a controller for controlling said flow controllers,
wherein said controller includes a calculation unit for calculating an amount of reaction byproducts generated in said process chamber, in accordance with the spectrum of the plasma emission detected with said spectrometer and an input unit for inputting a target timeline of the amount of reaction byproducts, and controls amounts of the process gasses in such a manner that a calculation result of the amount of reaction byproducts becomes coincident with the input target timeline.

2. The plasma processing system according to claim 1, wherein the target timeline of the amount of reaction byproducts is set in accordance with a target work cross sectional shape of a member to be worked as said specimen and an amount of radicals.

3. The plasma processing system according to claim 1, wherein said controller adjusts a total flow rate of a plurality of process gasses to be supplied, while maintaining constant of a flow rate ratio among the plurality of process gasses.

4. The plasma processing system according to claim 3, wherein said total flow rate is continuously adjusted in accordance with a slope angle of a target work cross sectional shape of a member to be worked as said specimen.

5. The plasma processing system according to claim 1, wherein said controller calculates an amount of oxygen radicals in accordance with the spectrum of the plasma emission detected with said spectrometer and adjusts an oxygen flow rate in accordance with a calculation result.

6. The plasma processing system according to claim 1, wherein said flow rate controllers are installed near said process chamber to set a delay time of flow rate control to 0.5 second or shorter.

7. The plasma processing system according to claim 1, wherein a total flow rate of the process gasses is controlled to be constant and a change in an amount of radicals with time is set in accordance with a target work cross sectional shape of a member to be worked as said specimen.

8. A plasma processing method of changing process gasses supplied to a process chamber to plasma by supplying a high frequency power and making a specimen placed on a specimen stage be subjected to a plasma process, comprising steps of:
detecting a spectrum of plasma emission generated in the process chamber;
calculating an amount of reaction byproducts generated in the process chamber, in accordance with the detected spectrum of the plasma emission; and
controlling flow rates of the process gasses in such a manner that a calculation result of the amount of reaction byproducts becomes coincident with a target timeline predetermined in accordance with a target work cross sectional shape.

9. The plasma processing method according to claim 8, wherein the target timeline of said amount of reaction byproducts is set in accordance with a slope angle of the target work cross sectional shape of a member to be worked as the specimen and an amount of radicals.
